(19) United States
(12) Patent Application Publication
(10) Pub. No.: US 2006/0070793 A1
(43) Pub. Date: Apr. 6, 2006

(54) Hydraulic system and forklift with the same

(75) Inventor: Michiro Akao, Kyoto (JP)

Correspondence Address: SUGHRUE MION, PLLC, 2100 PENNSYLVANIA AVENUE, N.W., SUITE 800, WASHINGTON, DC, 20037, US

(73) Assignee: NIPPON YUSOKI CO., LTD.

(21) Appl. No.: 11/222,859

(22) Filed: Sep. 12, 2005

(30) Foreign Application Priority Data
Sep. 10, 2004 (JP) P2004-264409

(51) Int. Cl. B62D 5/06

(52) U.S. Cl. 180/422

(57) ABSTRACT

The hydraulic system includes a hydraulic pump for supplying hydraulic oil to a hydraulic actuator, an electric motor for driving the hydraulic pump, hydraulic pipes provided between the hydraulic actuator and a tank, a hydraulic motor provided in one of the hydraulic pipes for recovering the hydraulic oil and adapted to be driven on receipt of the hydraulic oil which has been recovered from the hydraulic actuator, a drive transmitting device connected to both the hydraulic motor and the electric motor for transmitting driving torque from the hydraulic motor to the electric motor, and a control unit which conducts regenerative control of the electric motor according to rotation number of the electric motor, when the electric motor is driven by the hydraulic motor.

### BACKGROUND OF THE INVENTION

1. Field of the Invention

The present invention relates to a hydraulic system for actuating a movable member such as a loading tool, and a forklift provided with the hydraulic system.

2. Description of the Related Art

Heretofore, a hydraulic system in which a hydraulic actuator such as a hydraulic cylinder is employed in order to actuate a movable member has been adopted in vehicles and apparatuses of various types, such as a forklift. Moreover, it has been contrived to recover (regenerate) energy from motion of the movable member, by utilizing this hydraulic system. As for the forklift, for example, there has been proposed a so-called lift lowering regeneration art in which potential energy of a fork or a cargo is converted to electric energy when the fork is lowered, thereby to charge a battery.

As this lift lowering regeneration art, there has been such a method that a hydraulic pump is co-used as a hydraulic motor, as described in JP-A-02-169499 and JP-A-2003-252592, the hydraulic pump is rotated in a reverse direction (operated as the hydraulic motor) by hydraulic oil which is pushed out from a lifting and lowering hydraulic cylinder (a lift cylinder) when the lift is lowered, and further, an electric motor connected to the hydraulic pump is driven as an electric generator, thereby to charge the battery from the electric motor. Moreover, as described in JP-A-55-56999, the hydraulic motor is provided in a return passage from the lift cylinder, and the electric generator is connected to this hydraulic motor, thereby to charge the battery from the electric generator.

In the method as described in JP-A-02-169499, an electromagnetic clutch is provided between the electric motor and the hydraulic pump, so that power transmission may be interrupted by the electromagnetic clutch, in case where regeneration is impossible when the lift is lowered.

### SUMMARY OF THE INVENTION

According to the lift lowering regeneration technique as described above, it has been possible to constitute a system of high efficiency, because loss of the potential energy can be restrained. However, in case where the hydraulic pump is used as the hydraulic motor, and the electric motor for actuating the hydraulic pump is used as the electric generator, it has been impossible to feed return oil from the lifting and lowering hydraulic cylinder to the hydraulic pump, when the hydraulic oil is supplied to a hydraulic actuator for another operation (for example, a hydraulic cylinder for tilting the fork) while the lift is lowered, and hence, regeneration of electric power cannot be made. In other words, there has been a problem that regeneration of the electric power can be reliably conducted, only when the lift is lowered. There has been another problem that in case where the hydraulic oil starts to be supplied to another hydraulic cylinder while the regeneration of the electric motor is conducted, the reverse rotation of the hydraulic pump is abruptly converted to positive rotation from the reverse rotation, which causes a shock.

On the other hand, in case where the hydraulic pump and the hydraulic motor are respectively provided, and also, the electric motor and the electric generator are respectively provided, as described in JP-A-55-56999, it would be possible to regenerate the electric power while lowering the lift, even when the hydraulic oil is supplied to the other hydraulic cylinder, and a shock by the conversion will not happen. However, there has been another problem that this art is disadvantageous when adopted in a vehicle such as the forklift, because a larger installation space is required as compared with the case of co-using as described above, and incurs an increase of weight.

Those problems as described above are to be considered concerning not only the lift lowering regeneration technique, but also other regeneration technique in the hydraulic system.

It is an object of the invention to provide a hydraulic system which is more simplified in structure, and can be operated with high efficiency not only on occasion where only regenerating operation such as lowering a lift is conducted, but also on occasion where hydraulic oil is supplied to another hydraulic actuator during the regenerating operation. Moreover, it is another object of the invention to provide a forklift provided with such an efficient hydraulic system.

According to one aspect of the invention, there is provided with a hydraulic system including: a hydraulic actuator which actuates a movable member to make a determined motion; a hydraulic pump which supplies hydraulic oil from a tank which contains the hydraulic oil to the hydraulic actuator by an electric motor, wherein the hydraulic oil is recovered from the hydraulic actuator to the tank by a load which has been applied to the hydraulic actuator through the movable member in a state where the hydraulic oil is not supplied from the hydraulic pump; at least one hydraulic pipe disposed between the hydraulic actuator and the tank, the at least one hydraulic pipe including a hydraulic pipe which recoveries the hydraulic oil; a hydraulic motor provided in the hydraulic pipe which recoveries the hydraulic oil, the hydraulic motor driven on receipt of the hydraulic oil from the hydraulic actuator when the hydraulic oil is recovered from the hydraulic actuator; a drive transmitting device which is connected to both the hydraulic motor and the electric motor to transmit a driving torque from the hydraulic motor to the electric motor; and a control unit which conducts regenerative control of the electric motor according to rotation number of the electric motor, when the electric motor is driven by the hydraulic motor.

With this configuration, the hydraulic motor is driven by utilizing the hydraulic oil which has been recovered from the hydraulic actuator by the load received through the movable member, and the regenerative control is conducted on the electric motor which is driven by the hydraulic motor, thereby to regenerate electric power, and thus, efficiency of the hydraulic system can be enhanced. Moreover, even though the hydraulic pump is driven by the electric motor while the hydraulic motor is running, movement of the hydraulic motor will not be interrupted, but rather, the hydraulic pump can be driven by utilizing the driving torque from the hydraulic motor, without causing a shock on occasion of driving the hydraulic pump. Further, because the electric motor for driving the hydraulic pump is the same electric motor driven by the hydraulic motor, the installation space can be made smaller than the case where a separate electric generator (or an electric motor) is provided, and overall weight of the hydraulic system can be made relatively light.

It is possible to employ a hydraulic cylinder or a hydraulic motor, as the hydraulic actuator. Moreover, the hydraulic system in this specification is a generic name for collectively calling various devices related to operation of the hydraulic actuator and including the hydraulic actuator. Further, the description that the hydraulic actuator actuates the movable member to make a motion includes both a case where the hydraulic actuator directly actuates the movable member, and a case where the hydraulic actuator indirectly actuates the movable member, by transmitting driving power or driving torque from the hydraulic actuator by way of transmitting device such as a link mechanism.

According to another aspect of the invention, in the hydraulic system, the drive transmitting device may include a clutch device which can transmit the driving torque from the hydraulic motor to the electric motor only.

With this configuration, it is possible to reliably transmit the driving torque from the hydraulic motor to the electric motor. Moreover, it will not happen that the hydraulic motor is driven uselessly since the driving torque is transmitted from the electric motor to the hydraulic motor, and a loss of energy can be prevented.

According to another aspect of the invention, the control unit controls the electric motor to the determined rotation number required for driving the hydraulic pump when the hydraulic pump is driven for the purpose of supplying the hydraulic oil to the hydraulic actuator, and the control unit conducts the regenerative control of the electric motor in case where the rotation number of the electric motor is above the determined rotation number.

With this configuration, it is possible to reliably operate the hydraulic actuator, by keeping the determined rotation number required for driving the hydraulic pump. Additionally, it is possible to save the electric power required for power control of the electric motor, by utilizing the driving torque from the hydraulic motor for driving the hydraulic pump. Moreover, because superfluous driving torque can be recovered through the regenerative control, efficient operation can be attained.

According to another aspect of the invention, the movable member is a loading tool for handling a cargo, and the hydraulic actuator is operated by receiving a supply of the hydraulic oil from the hydraulic pump thereby to move the loading tool in a determined direction, and in a state where the hydraulic oil is not supplied from the hydraulic pump, the hydraulic actuator is operated by self-weights of the loading tool and the cargo handled by the loading tool, thereby to move the loading tool in an opposite direction to the determined direction.

With this configuration, it is possible to move the loading tool in the determined direction and in the opposite direction by the hydraulic actuator. Moreover, it is possible to drive the hydraulic motor by utilizing the hydraulic oil which has been recovered from the hydraulic actuator by receiving the self-weights of the loading tool and the cargo handled by the loading tool, and to conduct the regenerative control of the electric motor which is driven by the hydraulic motor, thereby to regenerate the electric power. Therefore, efficiency of the hydraulic system can be enhanced.

According to another aspect of the invention, the movable member is a loading tool for handling a cargo, and the hydraulic actuator includes a first hydraulic actuator which operates the loading tool to make a determined motion, and a second hydraulic actuator which operates the loading tool to make another motion different from the determined motion, or a third hydraulic actuator which operates another loading tool different from the loading tool, wherein the first hydraulic actuator is operated by a supply of the hydraulic oil from the hydraulic pump thereby to move the loading tool in a determined direction, and in a state where the hydraulic oil is not supplied from the hydraulic pump, the first hydraulic actuator is operated by self-weights of the loading tool and the cargo handled by the loading tool, thereby to move the loading tool in an opposite direction to the determined direction, the second or third hydraulic actuator is operated by a supply of the hydraulic oil from the hydraulic pump, and when the electric motor is driven by the hydraulic motor, and the hydraulic pump is driven for the purpose of supplying the hydraulic oil to the second or third hydraulic actuator, the control unit applies the regenerative control to the electric motor in case where the rotation number of the electric motor is above the determined rotation number.

With this configuration, it is possible to actuate the loading tool to perform a plurality of motions, by providing the first hydraulic actuator and the second hydraulic actuator, and it is possible to actuate a plurality of loading tools respectively to perform determined motions, by providing the first hydraulic actuator and the third hydraulic actuator. Moreover, it is possible to drive the hydraulic motor by utilizing the hydraulic oil which has been recovered from the first hydraulic actuator by receiving the self-weights of the loading tool and the cargo handled by the loading tool, and to conduct the regenerative control of the electric motor driven by the hydraulic motor thereby to regenerate the electric power. Therefore, efficiency of the hydraulic system can be enhanced. Further, even though the hydraulic pump is driven by the electric motor for the purpose of supplying the hydraulic oil to the second or third hydraulic actuator while the hydraulic motor is running, movement of the hydraulic motor will not be interrupted, but rather, the hydraulic pump can be driven by utilizing the driving torque from the hydraulic motor, thereby to operate the second or third hydraulic actuator. Therefore, the driving torque to be generated in the electric motor for supplying the hydraulic oil can be decreased by such an amount, and consumption of the electric power can be restrained.

According to another aspect of the invention, the hydraulic actuator includes at least a lifting and lowering hydraulic cylinder for lifting and lowering the loading tool, the hydraulic oil being supplied from the tank to the lifting and lowering hydraulic cylinder thereby to lift the loading tool, and being recovered from the lifting and lowering hydraulic cylinder to the tank thereby to lower the loading tool, wherein the hydraulic system includes a lifting and lowering control valve connected to both the lifting and lowering hydraulic cylinder and the tank respectively by hydraulic pipes, the control valve permitting a flow of the hydraulic oil from the tank to the lifting and lowering hydraulic cylinder when the hydraulic oil is supplied to the lifting and lowering hydraulic cylinder, and permitting a flow of the hydraulic oil from the lifting and lowering hydraulic cylinder to the tank when the hydraulic oil is recovered from the lifting and lowering hydraulic cylinder, the hydraulic pump is provided in the hydraulic pipe interconnecting the tank and the lifting and lowering control valve, and driven by the electric motor to suck in the hydraulic oil from the tank and discharge it to the lifting and lowering control valve, and the hydraulic motor is provided in the hydraulic pipe interconnecting the lifting and lowering hydraulic cylinder and the lifting and lowering control valve, and driven by the hydraulic oil from the lifting and lowering hydraulic cylinder when the hydraulic oil is recovered from the lifting and lowering hydraulic cylinder.

With this configuration, the flow of the hydraulic oil can be appropriately controlled by the lifting and lowering control valve, and on occasion of lowering the loading tool, it is possible to drive the hydraulic motor by reliably supplying the hydraulic oil from the lifting and lowering hydraulic cylinder to the hydraulic motor. Moreover, because the hydraulic oil is supplied to the hydraulic motor at a position closer to the lifting and lowering hydraulic cylinder than the lifting and lowering control valve, the hydraulic motor can be driven before the energy is lost due to a loss of the hydraulic oil flowing through the lifting and lowering control valve. Therefore, it is possible to generate the driving torque effectively in the hydraulic motor.

According to another aspect of the invention, the hydraulic pipe interconnecting the lifting and lowering hydraulic cylinder and the lifting and lowering control valve is diverged, in at least a part thereof, into a first pipe for supplying the hydraulic oil from the lifting and lowering control valve to the lifting and lowering hydraulic cylinder, and a second pipe for supplying the hydraulic oil from the lifting and lowering hydraulic cylinder to the lifting and lowering control valve, wherein the first pipe is provided with a first check valve which blocks a flow of the hydraulic oil from the lifting and lowering hydraulic cylinder to the lifting and lowering control valve, and the second pipe is provided with a second check valve which blocks a flow of the hydraulic oil from the lifting and lowering control valve to the lifting and lowering hydraulic cylinder, and the hydraulic motor is provided in the second pipe at a position closer to the lifting and lowering hydraulic cylinder than the second check valve.

With this configuration, on occasion of lowering the loading tool, it is possible to supply the hydraulic oil from the lifting and lowering hydraulic cylinder reliably to the hydraulic motor thereby to drive the hydraulic motor, and on occasion of lifting the loading tool, supply of the hydraulic oil to the hydraulic motor can be reliably prevented. Moreover, because the hydraulic oil is supplied to the hydraulic motor at the position closer to the lifting and lowering hydraulic cylinder, the hydraulic motor can be driven before the energy is largely lost due to a pipe loss or the like, and so, the driving torque can be generated more effectively in the hydraulic motor. The position closer to the lifting and lowering hydraulic cylinder than the second check valve means an upstream position when the hydraulic oil flows from the lifting and lowering hydraulic cylinder to the lifting and lowering control valve.

According to another aspect of the invention, a forklift provided with the hydraulic system according to the invention, and characterized in that the loading tool is a fork on which a cargo is placed, the fork being supported so as to be lifted and lowered along a mast which is provided on a vehicle body, the hydraulic actuator includes at least a lifting and lowering hydraulic cylinder for lifting and lowering the fork, the lifting and lowering hydraulic cylinder being extended with a supply of the hydraulic oil from the hydraulic pump thereby to lift the fork, and being contracted with self-weights of the fork and the cargo on the fork thereby to lower the fork, wherein the hydraulic motor is driven by the hydraulic oil which is recovered from the lifting and lowering hydraulic cylinder to the tank, when the lifting and lowering hydraulic cylinder is contracted.

With this configuration, it is possible to drive the hydraulic motor utilizing the hydraulic oil recovered from the lifting and lowering hydraulic cylinder by receiving the self-weights of the fork and the cargo on the fork, and to conduct the regenerative control of the electric motor which is driven by the hydraulic motor, thereby to regenerate the electric power. Moreover, because the energy which has been used for lifting the fork and the cargo on the fork can be utilized for driving the hydraulic pump, it is possible to enhance the efficiency of the hydraulic system and accordingly, to enhance efficiency as the fork lift. Further, because the electric motor for driving the hydraulic pump is the same electric motor driven by the hydraulic motor, the installation space can be made smaller than the case where a separate electric generator (or an electric motor) is provided, and upsizing of the forklift can be restrained. An overall weight of the hydraulic system can be made relatively light, and cost and so on for driving the forklift can be decreased.

According to another aspect of the invention, a forklift provided with the hydraulic system according to the invention, and characterized in that the loading tool is a fork on which a cargo is placed, the fork being supported so as to be lifted and lowered along a mast which is provided on a vehicle body, and so as to be tilted with respect to the vehicle body, the first hydraulic actuator includes a lifting and lowering hydraulic cylinder for lifting and lowering the fork, and the second hydraulic actuator includes a tilting hydraulic cylinder for tilting the fork, the lifting and lowering hydraulic cylinder being extended with a supply of the hydraulic oil from the hydraulic pump thereby to lift the fork, and being contracted with self-weights of the fork and the cargo on the fork thereby to lower the fork, and the tilting hydraulic cylinder being extended or contracted with a supply of the hydraulic oil from the hydraulic pump thereby to tilt the fork, wherein the hydraulic motor is driven by the hydraulic oil which is recovered from the lifting and lowering hydraulic cylinder to the tank, when the lifting and lowering hydraulic cylinder is contracted, and when the electric motor is driven by the hydraulic motor, and the hydraulic pump is driven for the purpose of supplying the hydraulic oil to the tilting hydraulic cylinder, the control unit conducts the regenerative control of the electric motor in case where the rotation number of the electric motor is above the determined number.

With this configuration, it is possible to drive the hydraulic motor utilizing the hydraulic oil recovered from the lifting and lowering hydraulic cylinder by receiving the self-weights of the fork and the cargo on the fork, and to conduct the regenerative control of the electric motor which is driven by the hydraulic motor, thereby to regenerate the electric power. Moreover, because the energy which has been used for lifting the fork and the cargo on the fork can be utilized for driving the hydraulic pump on occasion of extending and contracting the tilting hydraulic cylinder, it is possible to enhance the efficiency of the hydraulic system and accordingly, to enhance efficiency as the forklift. Of course, there will be no trouble, even though the tilting operation is effected while the fork and the cargo on the fork are lowered. Further, because the electric motor for driving the hydraulic pump is the same electric motor driven by the hydraulic motor, the installation space can be made smaller than the case where a separate electric generator (or an electric motor) is provided, and upsizing of the forklift can be restrained. An overall weight of the hydraulic system can be made relatively light, and cost and so on for driving the forklift can be decreased.

According to another aspect of the invention, it is possible to drive the hydraulic motor by utilizing the hydraulic oil which has been recovered from the hydraulic actuator by receiving the load through the movable member, and to conduct the regenerative control of the electric motor thereby to regenerate the electric power. Moreover, because the hydraulic pump can be driven by utilizing the driving torque from the hydraulic motor while the hydraulic motor is driven, it is possible to enhance the efficiency of the hydraulic system. Further, because the electric motor for driving the hydraulic pump is the same electric motor driven by the hydraulic motor, the installation space can be made smaller than the case where a separate electric generator (or an electric motor) is provided, and overall weight of the hydraulic system can be made relatively light.

According to another aspect of the invention, it is possible to drive the hydraulic motor utilizing the hydraulic oil recovered from the lifting and lowering hydraulic cylinder by receiving the self-weights of the fork and the cargo on the fork, and to conduct the regenerative control of the electric motor which is driven by the hydraulic motor, thereby to regenerate the electric power. Further, because the energy which has been used for lifting the fork and the cargo on the fork can be utilized for driving the hydraulic pump, it is possible to enhance the efficiency of the hydraulic system, and accordingly, to enhance efficiency as the fork lift.

### BRIEF DESCRIPTION OF THE DRAWINGS

FIG. 1 is a side view of a forklift according to an embodiment of the invention;

FIG. 2 is a block diagram of functions of the forklift according to the embodiment of the invention;

FIG. 3 is a hydraulic circuit diagram according to the embodiment of the invention;

FIG. 4 is a hydraulic circuit diagram according to the embodiment of the invention;

FIG. 5 is a hydraulic circuit diagram according to the embodiment of the invention;

FIG. 6 is a hydraulic circuit diagram according to the embodiment of the invention; and

FIG. 7 is a hydraulic circuit diagram according to the embodiment of the invention.

### DESCRIPTION OF THE PREFERRED EMBODIMENTS

Now, an embodiment of the invention which has been applied to a forklift of a counter balance type (hereinafter simply referred to as a forklift) will be described referring to the drawings.

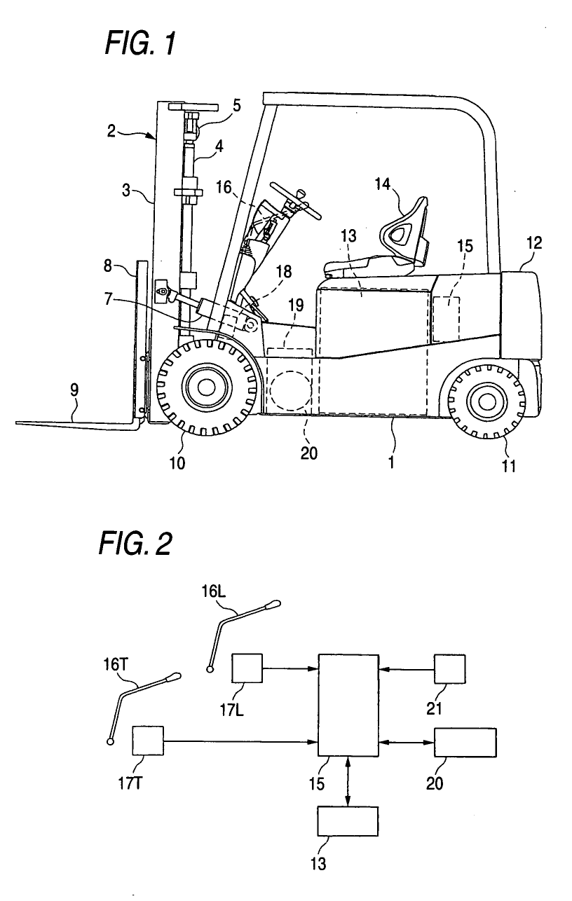

As shown in FIG. 1, a forklift in this embodiment has a mast device 2 in front of a vehicle body 1. The mast device 2 includes mainly, a mast member 3 which is supported in front of the vehicle body 1 so as to be tilted backward and forward, a lift cylinder 4 fixed in parallel to the mast member 3, a pulley 5 which is provided so as to move in association with extension and contraction of the lift cylinder 4 in the same direction, a chain 6 connected to the mast member 3 at its one end and connected at the other end to a lift bracket 8 which will be described below, and a tilt cylinder 7 bridged between the mast member 3 and the vehicle body 1. The lift bracket 8 provided with a back rest for preventing collapse of a cargo is held on this mast device 2 so as to be lifted and lowered, and a fork 9 is mounted on the lift bracket 8. This forklift is provided with a hydraulic system employing the lift cylinder 4 and the tilt cylinder 7.

The lift bracket 8 is supported by the mast member 3 by way of a roller, so as to be lifted and lowered along the mast member 3. The lift bracket 8 and accordingly, the fork 9 can be lifted and lowered by the extension and contraction of the lift cylinder 4. In this embodiment, the lift cylinder 4 is a rod-like hydraulic cylinder of single action type, which will be extended when hydraulic oil is supplied, and contracted when the hydraulic oil is recovered. The tilt cylinder 7 is a rod-like hydraulic cylinder of double action type, and the mast device 2 will be tilted forwardly (forward tilting) when the tilt cylinder 7 is extended, while the mast device 2 will be tilted backwardly (backward tilting) when the tilt cylinder 7 is contracted. Consequently, the lift bracket 8 supported by the mast device 2 and the fork 9 will be tilted with respect to the vehicle body 1. Although in the following description, it has been simply described for explanation, according to necessity, that the fork 9 is lifted and lowered by the lift cylinder 4, and the fork 9 is tilted by the tilt cylinder 7, what is meant by this description is as described above. Moreover, the hydraulic system is a generic name for collectively calling various devices related to the extension and contraction of the lift cylinder 4 and the tilt cylinder 7, inclusive of both the cylinders.

As shown in FIG. 1, the vehicle body 1 is provided with pairs of right and left front wheels 10 and rear wheels 11 respectively in a forward part and in a backward part below the vehicle body 1. The vehicle body 1 is further provided with a weight 12 at its backward end, and a battery 13 in a center part in a longitudinal direction of the vehicle body. A driver's seat 14 is mounted on a cover which covers an upper part of the battery 13. In addition, a control unit 15 is provided behind the battery 13, and an electric motor 20 and so on which will be described below will be controlled by this control unit 15.

A steering wheel for driving this forklift, levers, and switches are provided in a front area of the vehicle body 1, at a position opposed to the driver's seat 14. Among them, there is an operating lever 16 for actuating the mast device 2, which includes a lift operating lever 16L and a tilt operating lever 16T. The lift operating lever 16L for lifting and lowering the fork 9, and the tilt operating lever 16T for tilting the fork 9 are provided so as to be tilted respectively toward an operator and away from the operator. Moreover, the operating levers 16L, 16T are respectively provided with switches which will be turned on when operated, as shown in FIG. 2. A lift switch 17L will be turned on, when the lift operating lever 16L is operated in a direction of lifting the fork 9 (toward the operator), and a tilt switch 17T will be turned on, when the tilt operating lever 16T is operated in either direction of a direction of forwardly tilting the fork 9 and a direction of backwardly tilting the fork 9. Signals from the lift switch 17L and the tilt switch 17T will be inputted into the control unit 15, and the control unit 15 will control the electric motor 20 according to these signals.

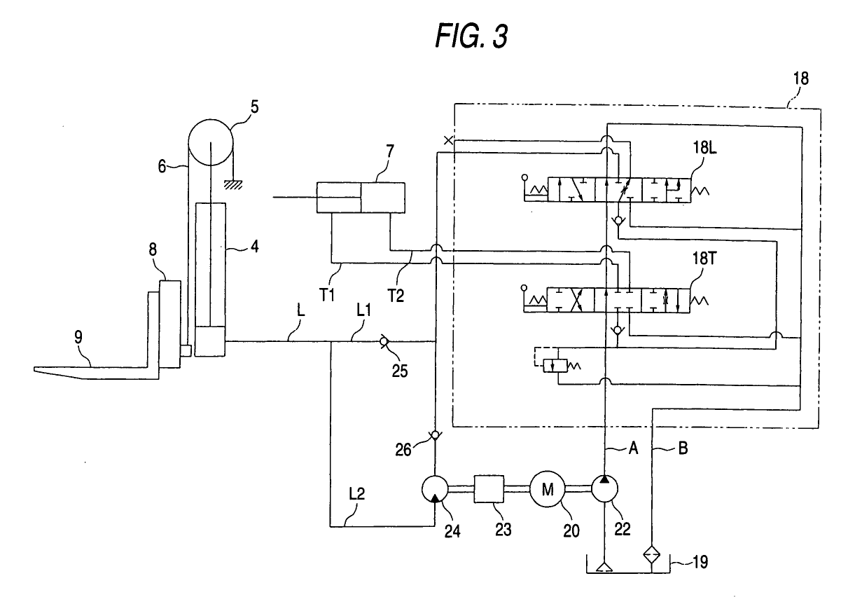

Further, the operating lever 16 is mechanically connected to a control valve 18 of manual operation type which is also provided in front of the vehicle body 1. As shown in FIG. 3, the control valve 18 includes a lift control valve 18L and a tilt control valve 18T. The lift operating lever 16L is connected to the lift control valve 18L, and the tilt operating lever 16T is connected to the tilt control valve 18T, in such a manner that the corresponding control valves may be respectively operated when the operating levers are operated.

As shown in FIG. 1, in a position ahead of the battery 13, there are provided a tank 19 for storing hydraulic oil to be supplied to the lift cylinder 4 and the tilt cylinder 7, and the electric motor 20 which is electrically connected to the battery 13 by way of the control unit 15. As shown in FIG. 3, a hydraulic pump 22 which sucks in the hydraulic oil and discharges it under pressure is connected to one end of a rotary shaft of the electric motor 20, and a hydraulic motor 24 which will be actuated by receiving the hydraulic oil by way of a one-way clutch 23 is connected to the other end. Both of them are mounted on the vehicle body 1 in a position ahead of the battery 13.

In this embodiment, the one-way clutch 23 is connected to both the rotary shaft of the electric motor 20 and a rotary shaft of the hydraulic motor 24, and can transmit driving torque only in one direction from the hydraulic motor 24 to the electric motor 20. The one-way clutch 23 will be idly rotated by the driving torque from the electric motor 20, and will not transmit the driving torque to the hydraulic motor 24. A rotation direction of the rotary shaft of the electric motor 20, when it drives the hydraulic pump 22, is made consistent with a rotation direction of the rotary shaft of the electric motor 20, when it is driven by the hydraulic motor 24. In addition, a rotation sensor 21 for detecting rotation number of the electric motor 20 is incorporated in the electric motor 20, and a signal from this rotation sensor 21 will be inputted into the control unit 15.

As shown in FIG. 3, the control valve 18 and the tank 19 are connected to each other by way of a supply tank pipe A for supplying the hydraulic oil from the tank 19 to the control valve 18 and a recovery tank pipe B for discharging the hydraulic oil from the control valve 18 to the tank 19. The tank pipe A is provided with the hydraulic pump 22. The tank pipes A and B are respectively connected to the lift control valve 18L and the tilt control valve 18T inside the control valve 18, so that the hydraulic oil may be supplied to both the control valves through the tank pipe A and may be recovered from both the valves through the tank pipe B.

The lift control valve 18L and the lift cylinder 4 are connected to each other by way of a lift pipe L. As shown in FIG. 3, a part of the lift pipe L is diverged to a supply lift pipe L1 for supplying the hydraulic oil from the lift control valve 18L to the lift cylinder 4, and a recovery lift pipe L2 for discharging the hydraulic oil from the lift cylinder 4 to the lift control valve 18L. The lift pipe L1 is provided with a check valve 25 for blocking a flow of the hydraulic oil from the lift cylinder 4 to the lift control valve 18L, while the lift pipe L2 is provided with a check valve 26 for blocking a flow of the hydraulic oil from the lift control valve 18L to the lift cylinder 4. Moreover, the lift pipe L2 is provided with the hydraulic motor 24 at a position close to the lift cylinder 4, as shown in FIG. 3. The tilt control valve 18T and the tilt cylinder 7 are connected to each other by way of a tilt pipe T1 which is connected to a rod side and a tilt pipe T2 which is connected to a bottom side.

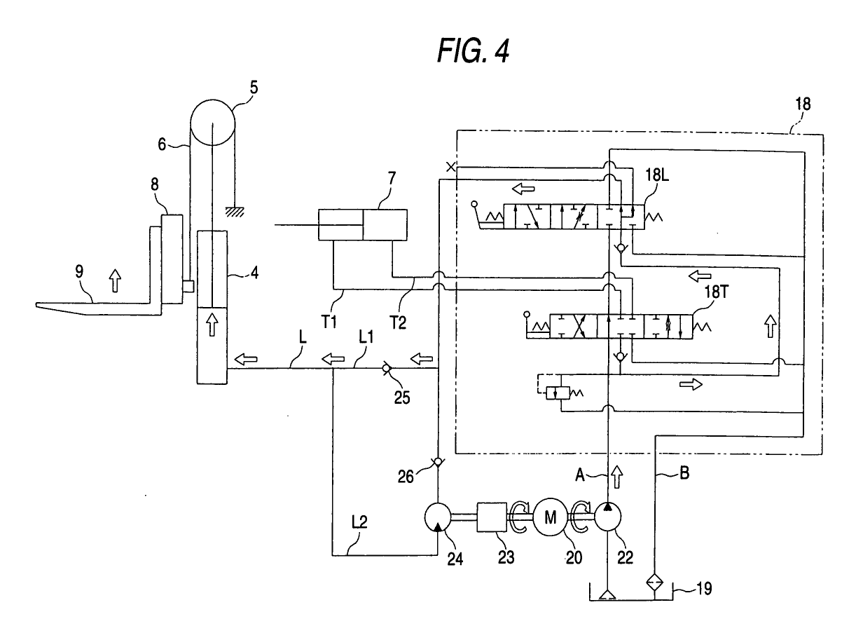

Lifting and lowering motions of the fork 9 in the forklift provided with the above described hydraulic system will be explained referring to FIGS. 4 to 7. Blank arrow marks in these drawings show movements of the respective parts and flows of the hydraulic oil.

In case of lifting the fork 9, the operator operates the lift operating lever 16L toward himself. Then, the lift switch 17L will be turned on, and on receipt of this on-signal, the control unit 15 will supply electric power from the battery 13 to the electric motor 20 for controlling the power, thereby to rotate the electric motor 20 at a determined rotation number. Synchronously with this rotation, the hydraulic pump 22 connected to the electric motor 20 will be driven. As shown in FIG. 4, the hydraulic pump 22 will suck in the hydraulic oil from the tank 19, and discharge the hydraulic oil under pressure to the lift control valve 18L. On this occasion, the lift control valve 18L has been open so that the hydraulic oil may flow from the hydraulic pump 22 to the lift cylinder 4 by the operation of the lift operating lever 16L. Accordingly, the hydraulic oil which has been supplied from the hydraulic pump 22 through the tank pipe A will flow through the lift control valve 18L, and then will be supplied to the lift cylinder 4 through the lift pipe L (the lift pipe L1). As the results, the lift cylinder 4 will be extended, and accordingly, the lift bracket 8 together with the fork 9 will be lifted upward by the chain 6.

When the electric motor 20 is driven, the driving torque will be also transmitted to the one-way clutch 23. However, this will cause only idle rotation of the one-way clutch 23, but the hydraulic motor 24 will not be driven by the electric motor 20. Besides, the flow of the hydraulic oil from the lift control valve 18L to the hydraulic motor 24 will be blocked by the check valve 26, and therefore, the hydraulic motor 24 is kept still.

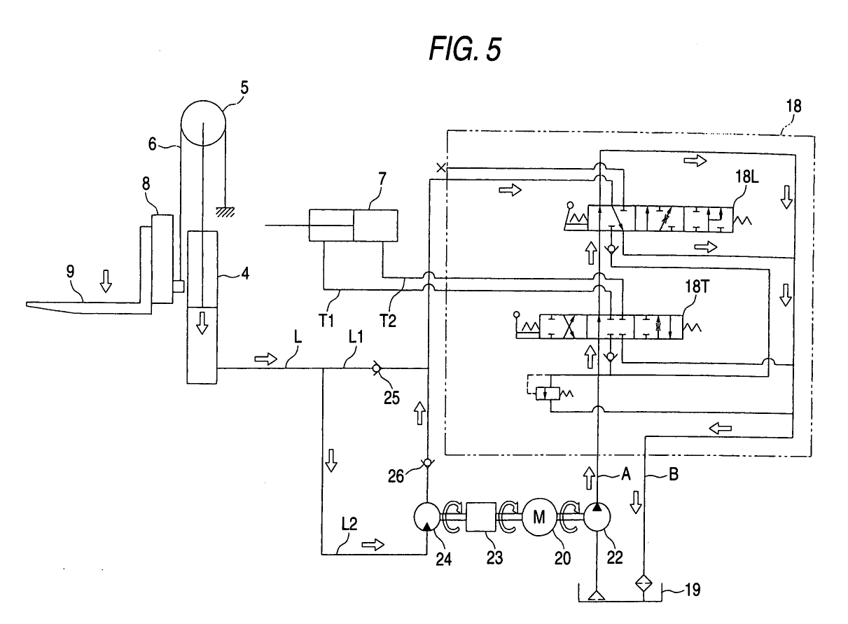

In case of lowering the fork 9, the operator operates the operating lever 16L away from himself. Then, as shown in FIG. 5, the lift control valve 18L will be opened so that the hydraulic oil may flow from the lift cylinder 4 to the tank 19. Because the rod of the lift cylinder 4 bears, as a load, self-weights of the lift bracket 8, the fork 9, the cargo placed on the fork 9 and so on, the hydraulic oil in the lift cylinder 4 will flow to the tank 19 through the lift pipe L (the lift pipe L2), when the lift control valve 18L is opened, as described above. This hydraulic oil will flow into the hydraulic motor 24 in the lift pipe L2, and the hydraulic motor 24 will be driven. When the hydraulic motor 24 has been driven, the driving torque will be transmitted to the electric motor 20 by way of the one-way clutch 23. The rotation number of the electric motor 20 at this moment will be inputted into the control unit 15 from the rotation sensor 21, and the control unit 15 will apply regenerative brake to the electric motor 20 in a reverse direction to the rotation by the driving torque, according to necessity, thereby to control the electric motor 20 at the determined rotation number. In other words, when the rotation number of the electric motor 20 is below the above mentioned determined rotation number, the regenerative control will not be conducted, but when the rotation number of the electric motor 20 is above the determined rotation number as described above, the regenerative control will be conducted. In this manner, the fork 9 will be lowered at the speed corresponding to the rotation number of the electric motor 20. Moreover, the control unit 15 will supply the regenerative electric power generated in the electric motor 20 to the battery 13, thereby to charge the battery 13. The hydraulic oil which has driven the hydraulic motor 24 and discharged from the hydraulic motor 24 will be recovered to the tank 19 through the lift control valve 18L and the tank pipe B.

The hydraulic pump 22 will be also driven synchronously, as the electric motor 20 is driven by the hydraulic motor 24, until the hydraulic oil stops to flow by lowering the fork 9 to the lowest position or by stopping the operation of the operating lever 16L to close the lift control valve 18L. For this purpose, the hydraulic oil is supplied to the lift control valve 18L from the tank 19 through the tank pipe A. However, as shown in FIG. 5, the hydraulic oil which has been supplied in this manner will pass by the control valve 18 uselessly, and will be merged with the hydraulic oil from the lift cylinder 4 to be recovered to the tank 19 through the tank pipe B.

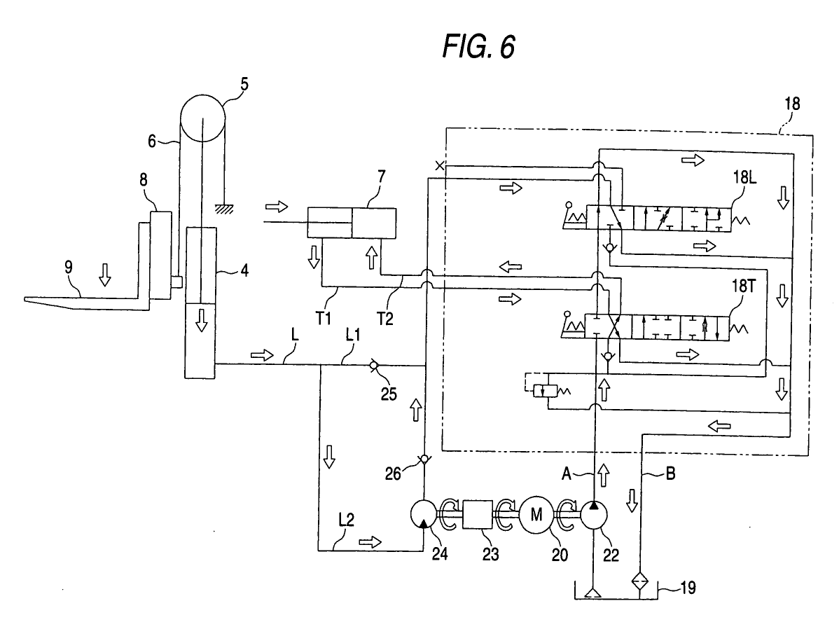

In case of lowering, and at the same time, tilting the fork 9 backward, the operator operates the tilt operating lever 16T toward himself, while he operates the lift operating lever 16L away from himself. Then, the tilt switch 17T will be turned on, and on receipt of this on-signal, the control unit 15 will drive the electric motor 20. The tilt control valve 18T is opened by the operation of the tilt operating lever 16T, as shown in FIG. 6, so that the hydraulic oil may flow from the hydraulic pump 22 to the rod side of the tilt cylinder 7 and may flow from the bottom side of the tilt cylinder 7 to the tank 19. Accordingly, the hydraulic oil from the hydraulic pump 22 which has been driven by the electric motor 20 will be supplied to the rod side of the tilt cylinder 7 through the tilt pipe T1, and the hydraulic oil will be recovered into the tank 19 from the bottom side of the tilt cylinder 7 through the tilt pipe T2. When the tilt cylinder 7 has been contracted in this manner, the mast member 3 and accordingly, the mast device 2 will be tilted in a manner of reclining backward, whereby the fork 9 will be tilted backward.

On this occasion, the hydraulic motor 24 will be driven along with the downward movement of the fork 9, as described above, and the driving torque from the hydraulic motor 24 will be transmitted to the electric motor 20 by way of the one-way clutch 23. For this reason, when the electric power is supplied to the electric motor 20 from the battery 13 to control the power, in the same manner as in case of operating the fork 9 to be tilted backward, an excessive amount of the driving torque corresponding to the driving torque from the hydraulic motor 24 will be transmitted to the hydraulic pump 22, rendering the hydraulic pump 22 to rotate more than required. Under the circumstances, the control unit 15 will apply the regenerative brake to the electric motor 20, when the rotation number of the electric motor 20 is above the determined rotation number required for driving the hydraulic pump 22, on the basis of the rotation number of the electric motor 20 received from the rotation sensor 21. In this manner, the electric motor 20 will be controlled at the determined rotation number. The regenerative electric power generated on this occasion will be supplied to the battery 13 thereby to charge the battery 13. After the control unit 15 has applied the regenerative brake to control the rotation number of the electric motor 20 at the determined rotation number, the rotation number will be kept. However, because the driving torque transmitted from the hydraulic motor 24 can be utilized, an amount of the driving torque to be generated in the electric motor 20 can be small correspondingly, and the battery 13 will be saved.

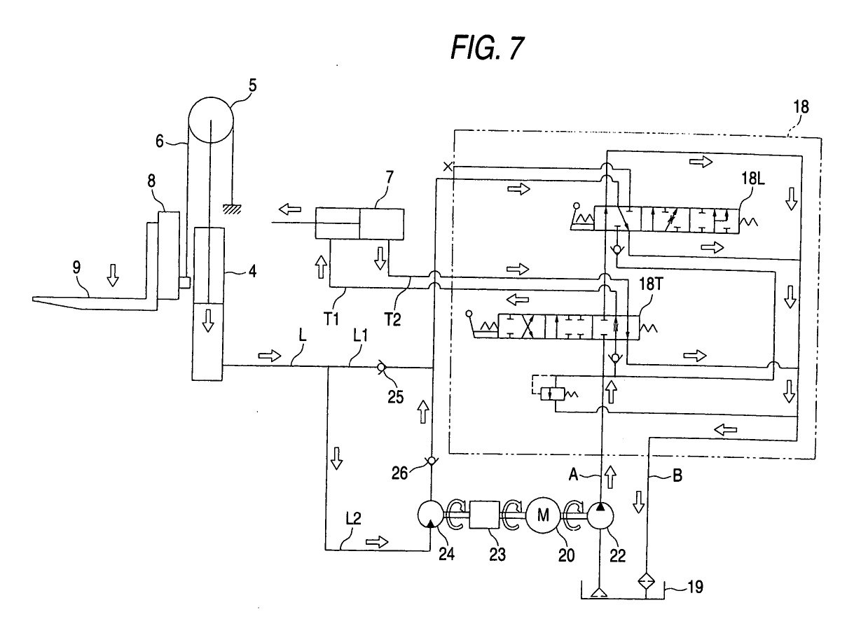

In case of lowering, and at the same time, tilting the fork 9 forward, the operator operates the tilt operating lever 16T away from himself, while he operates the lift operating lever 16L away from himself. Then, the tilt switch 17T will be turned on, and on receipt of this on-signal, the control unit 15 will drive the electric motor 20. The tilt control valve 18T is opened by the operation of the tilt operating lever 16T, as shown in FIG. 7, so that the hydraulic oil may flow from the hydraulic pump 22 to the bottom side of the tilt cylinder 7 and may flow from the rod side of the tilt cylinder 7 to the tank 19. Accordingly, the hydraulic oil from the hydraulic pump 22 which has been driven by the electric motor 20 will be supplied to the bottom side of the tilt cylinder 7 through the tilt pipe T2, and the hydraulic oil will be recovered into the tank 19 from the rod side of the tilt cylinder 7 through the tilt pipe T1. When the tilt cylinder 7 has been extended in this manner, the mast member 3 and accordingly, the mast device 2 will be tilted in a manner of reclining forward, whereby the fork 9 will be tilted forward.

In this case too, the hydraulic motor 24 will be driven along with the downward movement of the fork 9, and the driving torque from the hydraulic motor 24 will be transmitted to the electric motor 20 by way of the one-way clutch 23, in the same manner as in the above described case. The control unit 15 will apply the regenerative brake to the electric motor 20, when the rotation number of the electric motor 20 is above the determined rotation number required for driving the hydraulic pump 22, on the basis of the rotation number of the electric motor 20 received from the rotation sensor 21. In this manner, the electric motor 20 will be controlled at the determined rotation number, and the battery 13 will be charged with the regenerative electric power which has been generated on this occasion. Moreover, for the purpose of keeping the rotation number of the electric motor 20 at the determined rotation number, the driving torque transmitted from the hydraulic motor 24 can be utilized, and so, consumption of the electric power in the electric motor 20 can be saved.

According to this embodiment which has been described above, it is possible to conduct the regenerative control of the electric motor 20 to regenerate the electric power, by driving the hydraulic motor 24 utilizing the hydraulic oil which has been recovered from the lift cylinder 4, when the fork 9 is lowered. Therefore, it is possible to enhance efficiency of the system by recovering the energy which has been used for lifting the fork 9, and to enhance efficiency as the forklift. Moreover, because the electric motor 20 for driving the hydraulic pump 22 is the same electric motor 20 which is driven by the hydraulic motor 24, the space for installation can be made smaller as compared with a case of providing an electric generator separately, and the overall weight of the system can be made relatively light. As the results, upsizing of the forklift can be restrained, and cost for operating the forklift can be decreased.

Further, because the electric motor 20 and the hydraulic motor 24 are connected to each other by way of the one-way clutch 23, the rotation of the hydraulic motor 24 will not be hindered, even in case where the hydraulic pump 22 is driven by the electric motor 20 during the rotation of the hydraulic motor 24. It is rather possible to drive the hydraulic pump 22, by utilizing the driving torque transmitted from the hydraulic motor 24 by way of the one-way clutch 23. For this reason, the electric power required for the power control of the electric motor 20 can be saved, and the superfluous driving torque can be recovered through the regenerative control, very efficiently. In addition, in case of tilting the fork 9 forward or backward while the fork 9 is lowered, even though the hydraulic oil cannot be sufficiently supplied, the hydraulic pump 22 has been already driven by the driving torque from the hydraulic motor 24. Therefore, the rotation number can be smoothly increased as compared with the case of driving the hydraulic pump 22 from a standstill, and a shock will not happen in the lift cylinder 4, the tilt cylinder 7, the electric motor 20, and so on.

Still further, the hydraulic motor 24 is provided in the recovery lift pipe L2 at a position closer to the lift cylinder 4 than the check valve 26. Therefore, in case of lowering the fork 9, the hydraulic oil from the lift cylinder 4 can be reliably supplied to the hydraulic motor 24, thereby to drive the hydraulic motor 24, and at the same time, in case of lifting the fork 9, the hydraulic motor 24 can be reliably prevented from being supplied with the hydraulic oil. Moreover, because the hydraulic oil can be supplied to the hydraulic motor 24 at the position close to the lift cylinder 4, it is possible to drive the hydraulic motor 24 before the energy is lost by piping loss or the like, and it is possible to generate the driving torque more efficiently.

In the above described embodiment, the fork lift is provided with the lift cylinder 4 for lifting and lowering the fork 9, and besides, the tilt cylinder 7 for tilting the fork 9. However, the invention is not limited to this embodiment, but the forklift may be provided with a hydraulic cylinder for conducting a so-called reach motion in which the fork 9 (together with the mast device 2) can be moved back and forth, or a hydraulic cylinder for conducting a so-called side sift motion in which the fork 9 can be moved to right and left, or alternatively, may be provided with a plurality of these hydraulic cylinders. Further, the forklift may be provided with other loading tools, and attachment devices for conducting the loading works in cooperation with the fork 9, and hydraulic cylinders and hydraulic motors for actuating them. It is apparent that operating levers, switches for detecting their operations, and control valves may be provided, according to numbers and motions of the hydraulic cylinders and the hydraulic motors to be employed.

Although in this embodiment, the one-way clutch 23 is employed as a drive transmitting device according to the invention, it is possible to employ any other transmitting device which can transmit the driving torque from the hydraulic motor 24 to the electric motor 20, and cannot transmit the driving torque from the electric motor 20 to the hydraulic motor 24. Further, the invention can be applied not only to the forklift as shown in the above described embodiment, but also to vehicles and apparatuses of other types. It is also possible to apply the invention to any other hydraulic systems than the system in which the downward movement of the fork 9 is utilized to regenerate energy.

What is claimed is:

1. A hydraulic system comprising:
a hydraulic actuator which actuates a movable member to make a determined motion;
a hydraulic pump which supplies hydraulic oil from a tank which contains the hydraulic oil to the hydraulic actuator by an electric motor, wherein the hydraulic oil is recovered from the hydraulic actuator to the tank by a load which has been applied to the hydraulic actuator through the movable member in a state where the hydraulic oil is not supplied from the hydraulic pump;
at least one hydraulic pipe disposed between the hydraulic actuator and the tank, the at least one hydraulic pipe including a hydraulic pipe which recoveries the hydraulic oil;
a hydraulic motor provided in the hydraulic pipe which recoveries the hydraulic oil, the hydraulic motor driven on receipt of the hydraulic oil from the hydraulic actuator when the hydraulic oil is recovered from the hydraulic actuator;
a drive transmitting device which is connected to both the hydraulic motor and the electric motor to transmit a driving torque from the hydraulic motor to the electric motor; and
a control unit which conducts regenerative control of the electric motor according to rotation number of the electric motor, when the electric motor is driven by the hydraulic motor.

2. A hydraulic system according to claim 1, wherein
the drive transmitting device includes a clutch device operable to transmit the driving torque from the hydraulic motor to the electric motor only.

3. A hydraulic system according to claim 1, wherein
the control unit controls the electric motor to a determined rotation number required for driving the hydraulic pump when the hydraulic pump is driven to supply the hydraulic oil to the hydraulic actuator, and
the control unit conducts the regenerative control of the electric motor in case where the rotation number of the electric motor is above the determined rotation number.

4. A hydraulic system according to claim 1, wherein
the movable member is a loading tool for handling a cargo,
the hydraulic actuator is operated by receiving a supply of the hydraulic oil from the hydraulic pump thereby to move the loading tool in a predetermined direction, and
when the hydraulic oil is not supplied from the hydraulic pump, the hydraulic actuator is operated by self-weights of the loading tool and the cargo handled by the loading tool, thereby to move the loading tool in an opposite direction to the predetermined direction.

5. A hydraulic system according to claim 1, wherein
the movable member is a loading tool for handling a cargo, and
the hydraulic actuator includes a first hydraulic actuator operating operates the loading tool to make a determined motion and at least one of second hydraulic actuator operating the loading tool to make another motion different from the determined motion and third hydraulic actuator operating another loading tool different from the loading tool,
the first hydraulic actuator is operated by a supply of the hydraulic oil from the hydraulic pump thereby to move the loading tool in a predetermined direction, and
in a state where the hydraulic oil is not supplied from the hydraulic pump, the first hydraulic actuator is operated by self-weights of the loading tool and the cargo handled by the loading tool, thereby to move the loading tool in an opposite direction to the predetermined direction,
at least one of the second and the third hydraulic actuator is operated by a supply of the hydraulic oil from the hydraulic pump, and
the control unit conducts the regenerative control of the electric motor in case where the rotation number of the electric motor is above the determined rotation number, when the electric motor is driven by the hydraulic motor, and the hydraulic pump is driven to supply the hydraulic oil to at least one of the second hydraulic actuator and third hydraulic actuator.

6. A hydraulic system according to claim 4, wherein
the hydraulic actuator includes a lifting and lowering hydraulic cylinder which lifts and lowers the loading tool,
the lifting and lowering hydraulic cylinder supplies the hydraulic oil from the tank to the lifting and lowering hydraulic cylinder thereby to lift the loading tool, and
the lifting and lowering hydraulic cylinder recovers from the lifting and lowering hydraulic cylinder to the tank thereby to lower the loading tool,
a lifting and lowering control valve is connected to the lifting, lowering hydraulic cylinder, and the tank respectively by the hydraulic pipe
the lifting and lowering control valve permits a flow of the hydraulic oil from the tank to the lifting and lowering hydraulic cylinder when the hydraulic oil is supplied to the lifting and lowering hydraulic cylinder,
the lifting and lowering control valve permits a flow of the hydraulic oil from the lifting and lowering hydraulic cylinder to the tank when the hydraulic oil is recovered from the lifting and lowering hydraulic cylinder,
the hydraulic pump is provided in a hydraulic pipe interconnecting the tank and the lifting and lowering control valve,
the hydraulic pump is driven by the electric motor to suck in the hydraulic oil from the tank and discharge it to the lifting and lowering control valve,
the hydraulic motor is provided in the hydraulic pipe interconnecting the lifting and lowering hydraulic cylinder and the lifting and lowering control valve, and
the hydraulic motor is driven by the hydraulic oil from the lifting and lowering hydraulic cylinder when the hydraulic oil is recovered from the lifting and lowering hydraulic cylinder.

7. A hydraulic system according to claim 4, wherein
the hydraulic pipe interconnecting the lifting and lowering hydraulic cylinder and the lifting and lowering control valve is at least partially diverged into a first pipe for supplying the hydraulic oil from the lifting and lowering control valve to the lifting and lowering hydraulic cylinder, and a second pipe for supplying the hydraulic oil from the lifting and lowering hydraulic cylinder to the lifting and lowering control valve,
the first pipe is provided with a first check valve which blocks a flow of the hydraulic oil from the lifting and lowering hydraulic cylinder to the lifting and lowering control valve,
the second pipe is provided with a second check valve which blocks a flow of the hydraulic oil from the lifting and lowering control valve to the lifting and lowering hydraulic cylinder,
the hydraulic motor is provided in the second pipe at a position closer to the lifting and lowering hydraulic cylinder than the second check valve.

8. A forklift provided with the hydraulic system according to claim 4, wherein
the loading tool is a fork on which a cargo is placed, the fork being supported so as to be lifted and lowered along a mast which is provided on a vehicle body,
the hydraulic actuator includes at least a lifting and lowering hydraulic cylinder for lifting and lowering the fork, the lifting and lowering hydraulic cylinder being extended with a supply of the hydraulic oil from the hydraulic pump thereby to lift the fork, and being contracted with self-weights of the fork and the cargo on the fork thereby to lower the fork,
the hydraulic motor is driven by the hydraulic oil which is recovered from the lifting and lowering hydraulic cylinder to the tank, when the lifting and lowering hydraulic cylinder is contracted.

9. A forklift provided with the hydraulic system according to claim 5, wherein
the loading tool is a fork on which a cargo is placed,
the fork is supported to be lifted and lowered along a mast which is provided on a vehicle body, and
the fork is supported to be tilted with respect to the vehicle body,
the first hydraulic actuator includes a lifting and lowering hydraulic cylinder for lifting and lowering the fork, and the second hydraulic actuator includes a tilting hydraulic cylinder for tilting the fork,
the lifting and lowering hydraulic cylinder being extended with a supply of the hydraulic oil from the hydraulic pump thereby to lift the fork, and being contracted with self-weights of the fork and the cargo on the fork thereby to lower the fork, and
the tilting hydraulic cylinder being extended or contracted with a supply of the hydraulic oil from the hydraulic pump thereby to tilt the fork,
the hydraulic motor is driven by the hydraulic oil which is recovered from the lifting and lowering hydraulic cylinder to the tank, when the lifting and lowering hydraulic cylinder is contracted, and
when the electric motor is driven by the hydraulic motor, and the hydraulic pump is driven for the purpose of supplying the hydraulic oil to the tilting hydraulic cylinder, the control unit conducts the regenerative control of the electric motor in case where the rotation number of the electric motor is above the determined rotation number.
